(19) United States
(12) Patent Application Publication
(10) Pub. No.: US 2003/0003421 A1
(43) Pub. Date: Jan. 2, 2003

(54) Pre-impregnated disposable dental substance delivery mouthpiece

(76) Inventors: Thierry Bestenheider, Los Angeles, CA (US); Alexander Lebecki, Los Angeles, CA (US)

Correspondence Address: Thierry Bestenheider, 11693 San Vicente Blvd. #417, Los Angeles, CA, 90049, US

(21) Appl. No.: 09/898,331

(22) Filed: Jul. 2, 2001

(51) Int. Cl. A61C 5/00

(52) U.S. Cl. 433/215; 433/80

(57) ABSTRACT

Disposable dental mouthpiece-strip which has been pre-impregnated with dental substance which can either be placed in the mouth by the user or inserted in the mouth by a dentist for oral treatments, such as teeth whitening treatments, fluoride treatments, or medical treatments, such as the application of anasthetic or antimicrobal/antiseptic treatments.

The mouthpiece-strip is made with a foldable structure such as a thin strip of wax with a section of porous material (sponge) that holds the treatment dental product (liquid or gel). The mouthpiece-strip is disposable; the amount of time it is worn is determined by the type of dental treatment. The mouthpiece-strip may be adjusted in size by cutting it with scissors. The wax used for the mouthpiece is non-toxic and allows for a perfect adjustment in the mouth by contouring to the teeth during adjustment by the user. To enhance the fit in the mouth, the inner surface of the mouthpiece-strip may contain a thin layer of non-toxic sticky adhesive. The porous (sponge) strip attached to the wax strip is an inert, nontoxic material which is easy to process and inexpensive. It is attached to the wax strip with a non-toxic adhesive.

### CROSS REFERENCES TO RELATED APPLICATIONS

Not Applicable cl BACKGROUND—FIELD OF INVENTION

This invention relates to dental treatment, specifically to an improved disposable mouthpiece for delivering dental treatment substances.

### BACKGROUND—DESCRIPTION OF PRIOR ART

NEW USE:

In the past, conventional dental mouthpiece trays used in delivering dental substances have required a patient to go to a dental office and have an impression taken from which a plaster case would be made and over which a mouth piece would be formed by thermal techniques. Other, over the counter dental trays have been in the form of a standard, inaccurate one-size-fits-all device, which requires the user to use the same tray over and over, providing inaccurate results and limited hygene. A third method has been to provide for a pre-adapted shaped mouth piece, which is adjusted to the mouth's contours by the user's softening the device in boiling water and then biting on the device to form an impression. After the impression is formed, the user fills up the tray with dental substance. This will not result in a very accurate fit either, and the user also reuses the same, inaccurate tray over and over for repeated treatments.

This invention discloses a mouthpiece in the form of a disposable, wax-based strip adhered to a sponge strip. The sponge strip is pre-impregnated with high viscosity sustained release dental compositions, such as tooth bleaching or flouride compositions, for treating tooth and/or gum surfaces. A user takes the pre-impregnated, maleable wax/sponge strip and accurately forms it to the mouth's own contours for sustained delivery of dental compositions. Unlike prior similar items, the device may be pre-impregnated with dental treatment substance and it is disposable. Unlike dental trays which are used for repeated treatments and which require an initial contouring process and repeated impregnation of dental substances, this device is pre-impregnated with dental substances, is disposable, and is self-adjusted to the user's mouth contours by the user's self-adjustment.

The mouthpiece described in Fischer, U.S. Pat. No. 6,086,855 (2000) is an improved dental tray having reservoirs(or “scallops”)for holding dental composition adjacent to the tooth surface. This tray is used in combination with a dental composition, which is made especially viscous by including a high carboxypolymethylene concentration, so that dental compositions inserted into the tray are not diluted by the user's own saliva. It is the viscostity of the carboxypolymethylene composition which adds tackiness to the dental composition and helps to retain the tray in place by acting like glue against the teeth in the dental tray. This method requires someone to obtain an impression of the user's teeth, preparing a stone cast from the impression, forming a dental tray from the stone cast, and then scalloping the dental tray. The tray is then used over and over again, by washing it and then re-impregnating it with dental substance with each use.

Similarly, the dental tray in Fischer, U.S. Pat. No. 6,036,943 (2000) discloses a dental tray which is thin-walled, flexible and lightweight, which is then impregnated with a sticky, glue-like dental substance matrix material. The material again includes a tackifying carboxypolymethylene concentration to improve its sticky, glue-like quality against the teeth and to hold the mouthpiece in place, and the mouthpiece is used over and over again, by washing and then re-impregnating the mouthpiece with matrix material upon each use.

See also, generally, Fischer, U.S. Pat. No. 5,985,249 (1999), Fischer, U.S. Pat. No. 5,851,512 (1998), Fischer, U.S. Pat. No. 5,759,038 (1998), Fischer, U.S. Pat. No. 5,725,843 (1998), Munro, U.S. Pat. No. Re. 34,196 (1993), Munro, U.S. Pat. No. 4,990,089 (1991).

In Torres-Zaragoza, U.S. Pat. No. 4,983,381 (1991) teeth whitening is accomplished by covering the crowns of a patient's teeth with a metallic plate containing a thermic heating unit and an absorbent material with a chemical whitening product. During treatment a separator product and chemical and physical (metallic) protectors are used so that the whitening product remains insulated in the tooth for up to 48 hours after treatment. Ultra violet rays are then applied to ‘seal in’ the whitening product on the tooth. This necessarily requires an office visit where the apparatus inserted in the mouth upon each treatment.

Smith, U.S. Pat. No. 4,902,227 (1990) is a molded, one piece plastic dental tray for applying dental substances. See also,generally, Osborne, U.S. Pat. No. 4,560,351 (1985), Schaeffer, U.S. Pat. No. 4,528,180 (1985), Seid, U.S. Pat. No. 4,428,373 (1984), Aardse, U.S. Pat. No. 4,376,628 (1983), Olson, U.S. Pat. No. 4,251,507 (1981), Jacobs, U.S. Pat. No. 4,173,505 (1979), Lentine, U.S. Pat. No. 4,173,219 (1979), Quinby, U.S. Pat. No. 4,164,940 (1979), Weitzman, U.S. Pat. No. 4,064,628 (1977), and Gores, U.S. Pat. No. Re. 28,667.

The dental tray disclosed in Weitzman, U.S. Pat. No. 3,955,281, is a disposable dental tray having a U-shaped cross-section and containing a flexible polymeric foam material. The flexibility of the tray is designed to provide a relatively snug seal between the tray perimeter and the peridontal tissue so as to prevent excessive loss of dental substance (which must be impregnated into the tray) through dilution from saliva. The interior recess of U-shaped cross-section formed in the tray is configured with indentations along its bottom surface and side walls which anatomically mate with the mouth's dentition pattern. This configuration, however, necessarily results in uneven application of dental substance, since the inner portion of the mouthpiece is ‘formed’ when the user's teeth press against the foamy substance and squish the dental substance upwards and out of the tray, toward the gums, in the process.

The present mouthpiece disclosed in this invention is disposable after each use, and is applied to the teeth by the user himself for accurate fitting around the user's own, unique teeth. Dental substances, such as whitening agents, fluoridation agents, anticarciogenic agents, antimicrobal agents, and desensitizing agents, etc., are applied to the mouth and gums by sponge material which has already been pre-impregnated with such substance, resulting in an easy, hygenic, uniform and effective method of treatment.

### SUMMARY INCLUDING OBJECTS AND ADVANTAGES

A means for delivering dental treatment substances to the teeth and gums comprising a flexible, malleable strip which is pre-impregnated with dental treatment substance and wrapped by the user around the teeth and gums.

### OBJECTS AND ADVANTAGES

Accordingly, several objects and advantages of the invention include the fact that the mouthpiece is disposable, and therefore more hygenic and sanitary than a pre-formed mouthpiece which is subjected to multiple uses in the mouth. The mouthpiece is also highly accurate, because its soft composition allows the user to form the mouthpiece around his teeth, so that it fits his specific teeth and gums. The mouthpiece also delivers uniform application of dental substance, since the mouthpiece's inner sponge is uniformally pre-impregnated with dental substance and since the sponge does not allow the substance to be squished out of the mouthpiece or diluted by contact with saliva. The sponge in the mouthpiece may also be used after oral surgery, not only to deliver post surgical substances, such as antiseptic or other healing agents, but also to facilitate healing by acting as a kind of ‘band aid’ on the teeth and/or gums after surgery.

The mouthpiece will give the dentist a very convenient tool for various applications in the mouth for tooth or gum treatments. No costly custom made dental trays are required to apply tooth whitening or fluoration gel. This allows the dentist to provide the patient with a ready-to-use mouthpiece regardless of the patient's mouth shape or size. It can be used in the lower or upper jaw without any waiting period, as is required when making custom trays.

The purpose of this mouthpiece-strip is to give the dentist and his patients a very convenient tool for various applications in the mouth for tooth or gum treatments. This allows the dentist to provide the patient with a ready-to-use mouthpiece regardless of mouth size or particular idiosyncrasies, and to be used in the upper and lower jaws without any waiting period and without the necessity of multiple office visits, as needed with many custom trays. The patient will be able to adjust the size of the mouthpiece-strip by cutting it and will be able to use a new mouthpiece every day. In case of surgery, the dentist can use the mouthpiece, or a part of it, impregnated with an antiseptic, on the operated area to increase the patient's comfort and to promote healing. A surgical variation of the strip may be made with a foldable strip made out of a light curing resin, which will allow the dentist to harden the strip in place so that it will stay in place for several days during post operative healing.

Still further objects and advantages will become apparent from a consideration of the ensuing description and accompanying drawings.

### BRIEF DESCRIPTION OF THE DRAWINGS

FIG. 1a is a side-view of a front tooth, with the mouthpiece ready to be placed in the mouth for tooth treatment.

FIG. 1b is a side-view of a front tooth with the mouthpiece in process of being adjusted in the mouth for tooth treatment.

FIG. 1c is a side-view of a front tooth with the mouthpiece adjusted in the mouth for tooth treatment. 1-foldable structure (eg., wax) 2-porous material (eg., sponge) 3-tooth.

FIG. 2a is a lengthwise side-view of the mouthpiece.

FIG. 2b is a top view of the mouthpiece. 1-foldable structure (eg., wax) 2-porous material (eg., sponge).

FIG. 3a is a front partial view of the mouthpiece ready to be placed in the mouth for tooth treatment.

FIG. 3b is a front parital view of the mouthpiece in the process of being adjusted in the mouth for tooth treatment.

FIG. 3c is a front partial view of the mouthpiece which has been adjusted in the mouth for tooth treatment.

FIG. 4a is a side-view of a front tooth with the mouthpiece ready to be placed in the mouth for tooth treatment.

FIG. 4b is a side-view of a front tooth with the mouthpiece in the process of being adjusted in the mouth for tooth treatment.

FIG. 4c is a side-view of a front tooth with the mouthpiece adjusted in the mouth for tooth treatment.

FIG. 5a is a lengthwise side-view of the mouthpiece.

FIG. 5b is a top-view of the mouthpiece.

FIG. 6a is a front partial view of the mouthpiece ready to be placed in the mouth for tooth treatment.

FIG. 6b is a front partial view of the mouthpiece in the process of being adjusted in the mouth for tooth treatment.

FIG. 6c is a front partial view of the mouthpiece which has been adjusted in the mouth for tooth treatment.

### REFERENCE NUMERALS

1 mouthpiece strip

2 porous material

3 tooth

Preferred Embodiment—Description

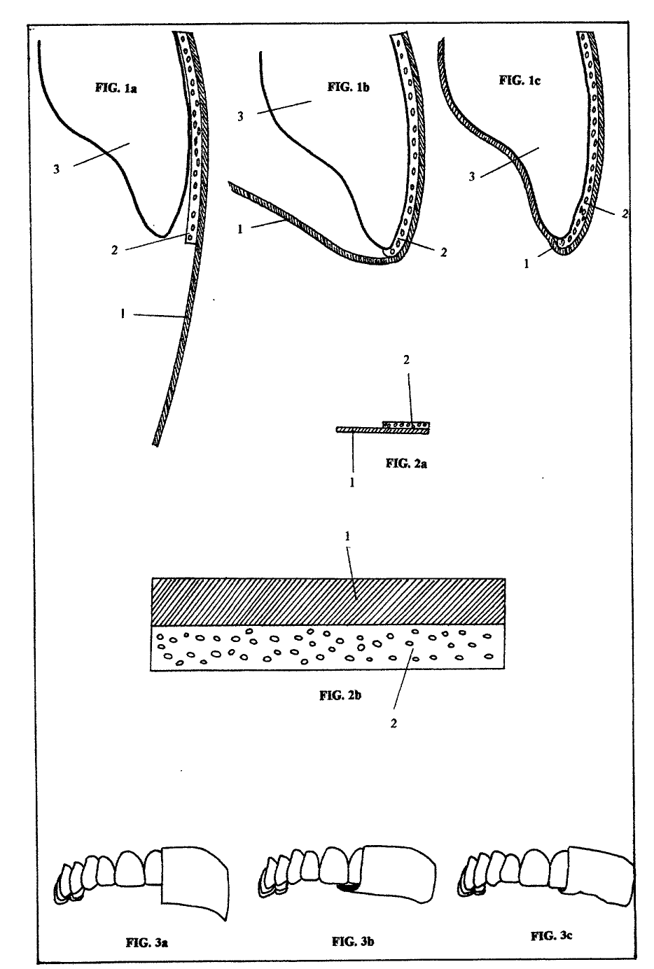

As shown in FIG. 2b and 2a, the mouthpiece is made as a foldable rectangular structure from a flexible material, such as a thin strip of wax. FIG. 2a-1. (The user folds the structure around the teeth and gums, as shown in FIG. 1a, 1b, and 1c, and as shown in FIG. 3a, 3b, and 3c.) A section of porous material, such as sponge, that will hold the treatment dental product (ie., liquid or gel) has been attached to the strip. FIG. 2a-2.

The thickness of the strip may vary depending on the type of dental treatment. As shown in FIG. 2b, the porous section covers the entire length of the strip, it but can vary in its width; therefore, the proportion between the surface of the foldable rectangular structure (FIG. 2a-1) and the porous, sponge material (FIG. 2a-2) will vary according to the product used in treatment.

For example, after gum surgery (when a form of the mouthpiece would be impregnated with antiseptic or pain killer) the FIG. 2a-2 sponge part would be wider and placed differently on the strip in order to cover the gum surface which has been operated on. For tooth whitening or fluoridation, however, the FIG. 2a-2 sponge part would more likely cover the tooth surface, and may be narrower.

To increase the fit in the mouth, the inner surface of the stip may be made with a thin layer of nontoxic sticky adhesive. The porous (sponge) structure is an inert, nontoxic material.

Preferred Embodiment—Operation

Operation and use of the mouthpiece is simple and straightforward. The FIG. 2b combined wax/sponge strip is placed in the mouth, and the user folds it to fit around his teeth, as shown in FIG. 1a, 1b, and 1c and as shown in FIG. 3a, 3b, and 3c. The strip can be used with a variety of dental treatment substances (liquids or gels), including, for example, gels for whitening, or an anesthetic product for superficial anesthesia before tooth cleaning with sensitive patients or with an antimicrobal or antiseptic agent for post-surgery use.

The mouthpiece is disposable and therefore is to be used once and replaced by a new mouthpiece for each treatment. The period of time the mouthpiece is worn will vary according to the type of treatment used with the mouthpiece.

The patient will also be able to adjust the size of the mouthpiece by cutting it and using a new one every day. In the cawse or surgery, the dentist can use this mouthpiece, or a part of it, impregnated with an antiseptic on the operated area to increase the patient's comfort and to allow daily cleaning or antiseptic treatment of the affected area.

### OTHER EMBODIMENTS

Adjustable Size—Description

The porous surface may also be broken into two or more pieces to allow a better adjustment improving the folding of the mouthpiece. If needed, the mouthpiece's size may be adjusted by cutting it with scissors.

Adjustable Size—Operation

The strip is used as described above, by folding in the same way over the teeth and gums.

Foldable Strip with Grooves Instead of Sponge—Description

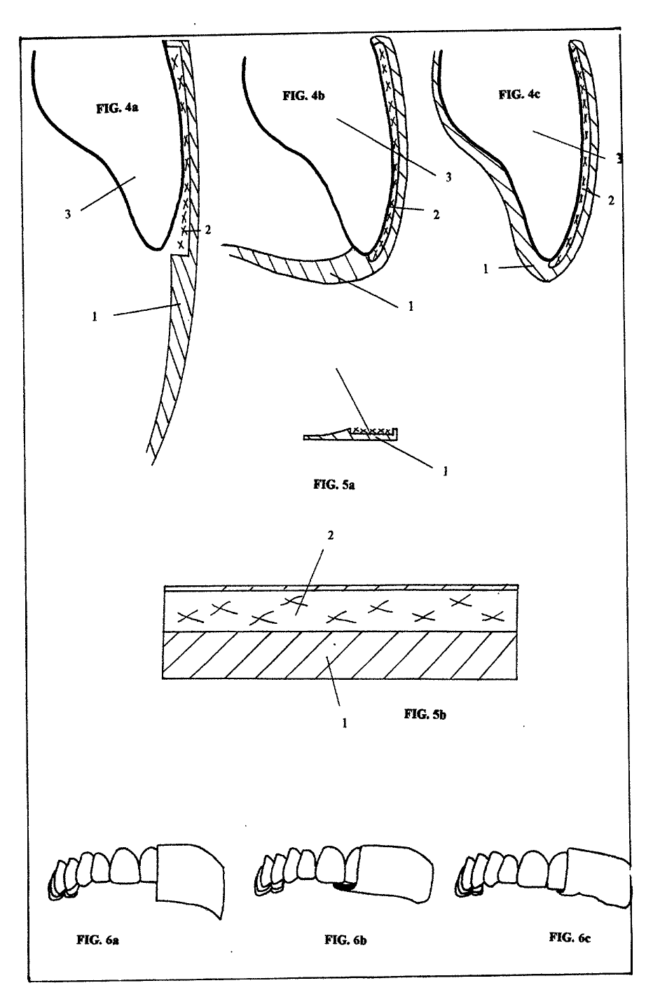

A variation of the mouthpiece may be made without the porous/spongy section attached; rather, one or more grooves, which retain dental treatment substances, may be substituted in place of the porous strip, as shown in FIG. 5a and 5b. (The strip is also folded around the teeth and gums, as shown in FIG. 4a, 4b, and 4c and as shown in FIG. 6a, 6b and 6c.)

Foldable Strip With Grooves Instead of Sponge—Operation

The strip is used as described above, by folding in the same way over the teeth and gums.

Foldable Strip Made of Curing Resin—Description

For surgical use, a variation of the mouthpiece will be available with a foldable strip made out of a light curing resin which will allow the dentist to harden the mouthpiece in place if it is necessary to keep the mouthpiece in place for an extended period of several days.

Foldable Strip Made of Curing Resin—Operation

The strip is used as described above, by folding in the same way over the teeth and gums.

Conclusions, Ramifications, and Scope

Accordingly, it can be seen that this invention provides a safe, hygenic, accurate, and uniform method for the delivery of dental substances to patients, in a convenient, comfortable, inexpensive, and disposable format.

Although the description above contains many specificities, these should not be construed as limiting the scope of the invention but as merely providing illustrations of some of the presently preferred embodiments of this invention. Various other embodiments and ramifications are possible within it's scope.

For example, the maleable strip may also be utilized in oral surgery applications as a kind of post operation ‘band aid,’ and may also be created in a light curing resin form, to allow the dental surgeon to harden the mouthpiece so that it stays in place for a number of days while healing takes place after oral surgery. The strip may be folded to fit over an enitre row of teeth, or it may be cut and shaped to fit a specific number of teeth, or to fit over a single tooth or tooth area within the mouth.

Thus the scope of the invention should be determined by the appended claims and their legal equivalents, rather than by the examples given. curing resin form, to allow the dental surgeon to harden the mouthpiece so that it stays in place for a number of days while healing takes place after oral surgery. The strip may be folded to fit over an enitre row of teeth, or it may be cut and shaped to fit a section or specific number of teeth, or to fit over a single tooth or tooth area within the mouth.

Thus the scope of the invention should be determined by the appended claims and their legal equivalents, rather than by the examples given:

What is claimed is:

1. Means for delivering dental substances whereby dental treatment substance is brought into contact with teeth and gums consisting of:
(a) Impregnating a strip of malleable material with dental treatment substance; and
(b) Wrapping said strip around the teeth and gums.

2. The means of claim 1 further including grooves in said strip to hold dental treatment substance.

3. The means of claim 1 further including a strip of pourous material attached along the length of said strip to hold dental treatment substance.

4. The means of claim 1 wherein said malleable material consists of resin which may be hardened using ultra violet light.

5. Method for preparing dental mouthpiece for use in applying dental treatmet compositions to a person's teeth, the method comprising the steps of:
(a) Cutting a strip of malleable material to fit in a person's mouth; and
(b) Wrapping said mouthpiece around the teeth and gums.

6. The method of claim 5 further including grooves in said strip to hold dental treatment substance.

7. The method of claim 5 further including a strip of pourous material attached along the length of said strip to hold dental treatment substance.

8. The method of claim 1 wherein said strip is comprised of resin which may be hardened using ultraviolet light.

9. Dental treatment substance delivery device comprising:
(a) A preimpregnated strip of malleable material which folds over the teeth and gums.

10. The device of claim 9 further including grooves in said strip to hold dental treatment substance.

11. The device of claim 9 further including a strip of pourous materail attached along the length of said strip to hold dental treatment substance.

12. The device of claim 9 wherein said strip is comprised of resin which may be hardened using ultra violet light.
